(19) United States
(12) Patent Application Publication
(10) Pub. No.: US 2006/0189202 A1
(43) Pub. Date: Aug. 24, 2006

(54) Cable pair test adapter

(76) Inventor: James Paul Lopez, Elgin, TX (US)

Correspondence Address: Matthew E. Burr;Moster Wynne, Suite 200, 2219 Westlake Drive, Austin, TX, 78746, US

(21) Appl. No.: 11/063,227

(22) Filed: Feb. 22, 2005

(51) Int. Cl. H01R 13/58

(52) U.S. Cl. 439/467

(57) ABSTRACT

A device that specifically addresses cable pair test access problems to provide an adapter that facilitates easy and safe connection of the meter to the midspan repeater case slot cable pairs. The device is rugged, simple in design, passive, and very easy to use. Also disclosed are methods for testing cable pairs and kits that include the adapter for testing midspan repeater cable pairs.

### FIELD OF THE INVENTION

The present invention relates to telecommunications, and in particular to a cable pair test adapter for testing midspan repeater cable pairs.

### BACKGROUND OF THE INVENTION

Currently, there is an adapter used by some telephone companies to check cable pairs in enclosures where the midspan repeater is easily accessible on the end. Where the Repeater is not easily accessible, however, testing a cable pair is often problematic and potentially dangerous. For example, when working in manholes, movement may be restricted. This makes access difficult. Makeshift or jerry-rigged hookups for testing create a shock hazard.

The test adapter of the present invention specifically addresses test access problems to provide an adapter that facilitates easy and safe connection of the meter to the midspan repeater case slot cable pairs. The device is rugged, simple in design, passive, and very easy to use.

### BRIEF DESCRIPTION OF THE DRAWINGS

The present invention is further described in the detailed description that follows, by reference to the noted drawings, by way of non-limiting examples of embodiments of the present invention, in which reference numerals represent similar features throughout the several views of the drawings, and in which:

FIG. 1 is an isometric top view of an adapter of the present invention.

FIG. 2 is a side view of the adapter of FIG. 1.

FIG. 3 is an isometric side and top view of the adapter of FIG. 1.

FIG. 4 is an isometric bottom and side view of the adapter of FIG. 1.

FIG. 5 is a schematic circuit drawing of a specific embodiment of the present invention.

FIG. 6 is schematic side view drawing of a loop jumper of specific embodiment of the present invention.

In view of the foregoing, the present invention, through one or more of its various aspects, embodiments and/or specific features or sub-components, is thus intended to bring out one or more of the advantages that will be evident from the description. The present invention is described with frequent reference to cable pair testing. It is understood that pair testing is merely an example of a specific embodiment of the present invention, which is directed broadly to electrical adapters, together with attendant systems and methods within the scope of the invention. The terminology, therefore, is not intended to limit the scope of the invention.

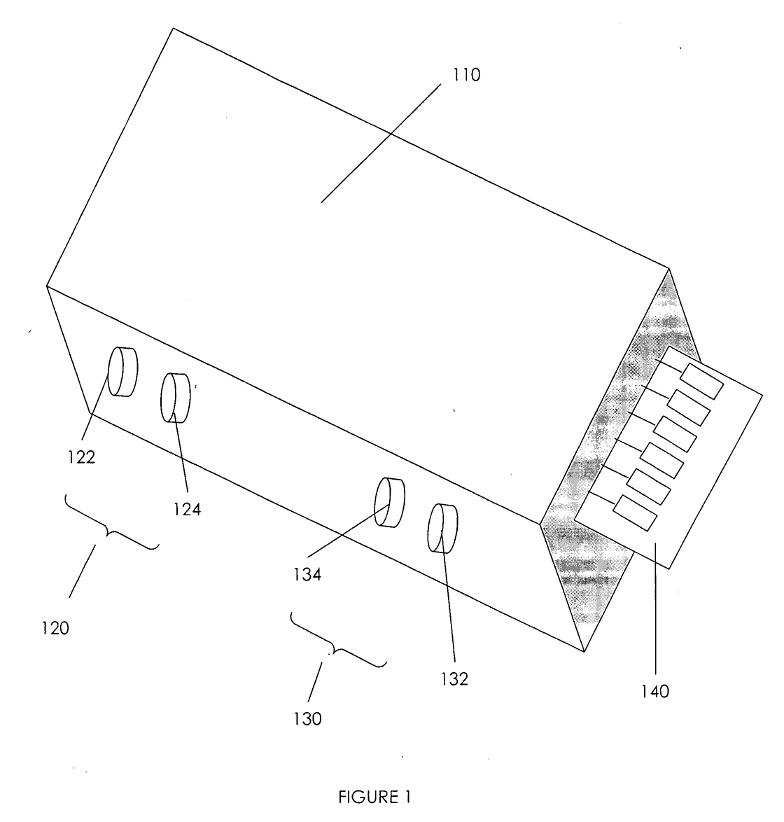

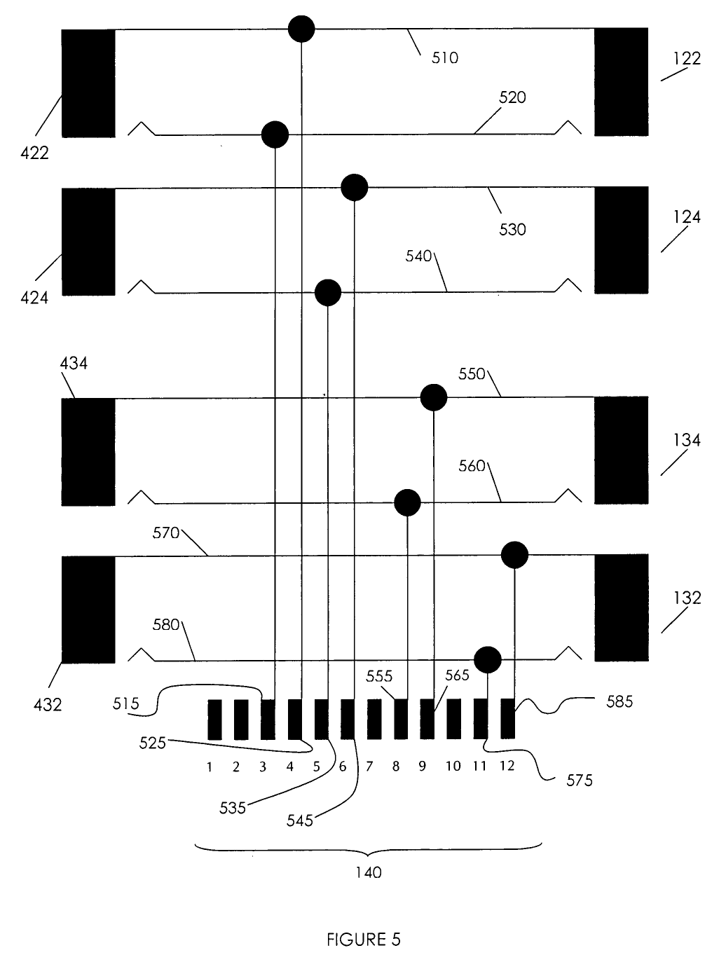

FIG. 1 is an isometric top view of an adapter of the present invention. Adapter 110 provides transmit low jacks 120, which includes “to field” jack 122 and “from C.O.” jack 124. “Receive High” jacks 130 include “from field” jack 132 and “to C.O.” jack 134 (“C.O.” refers to the central office). Connector 140 provides pins that lead to jacks 120 and 130. The pins are described in more detail in the description of FIG. 5, below. The pin assembly of connector 140, as shown in FIG. 1, is for illustrative purposes only and is not intended to describe any particular number, arrangement or form of pins.

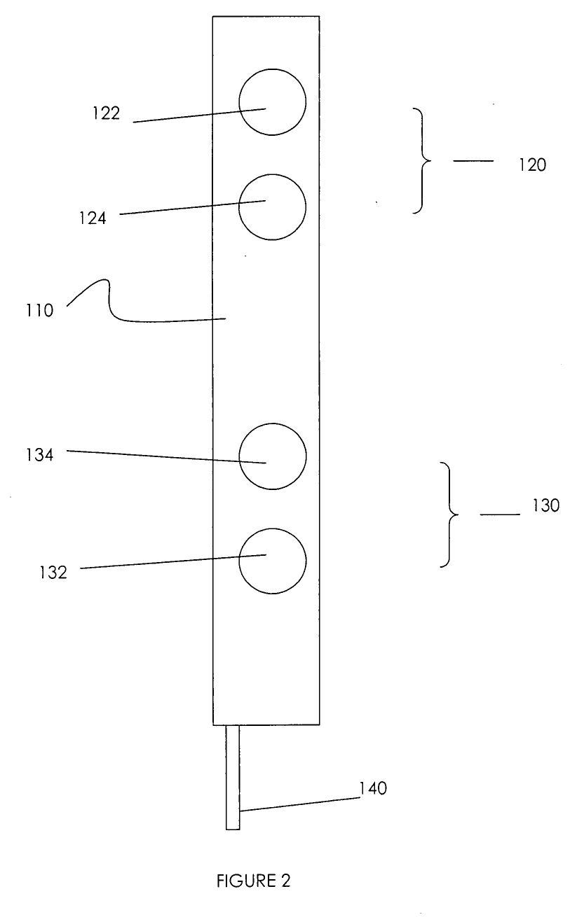

FIG. 2 is a side view of the adapter of FIG. 1. Adapter 110 provides transmit low jacks 120, which includes “to field” jack 122 and “from C.O.” jack 124. “Receive High” jacks 130 include “from field” jack 132 and “to C.O.” jack 134. Connector 140 provides pins that lead to jacks 120 and 130.

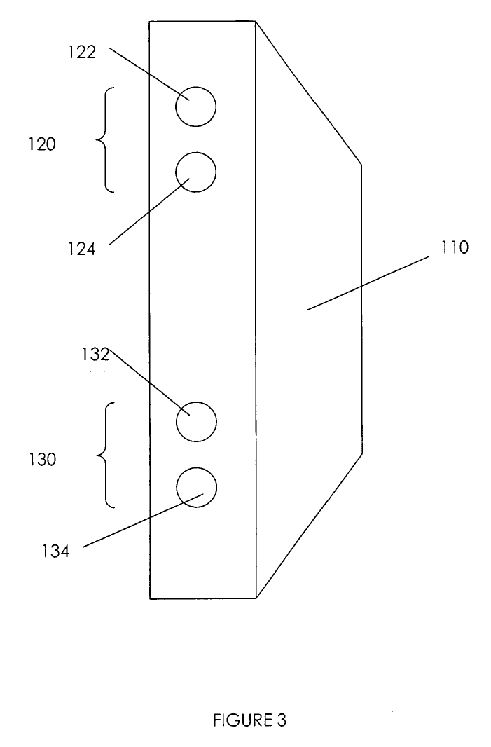

FIG. 3 is an isometric side and top view of the adapter of FIG. 1. Adapter 110 provides transmit low jacks 120, which includes “to field” jack 122 and “from C.O.” jack 124. “Receive High” jacks 130 include “to C.O.” jack 132 and “from field” jack 134. Connector 140 is not shown in this view of FIG. 3.

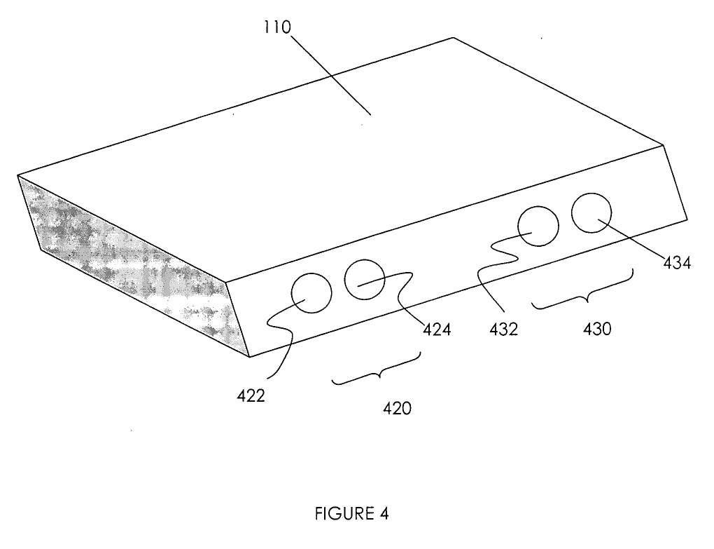

FIG. 4 is an isometric bottom and side view of the adapter of FIG. 1. In the view of FIG. 4, Adapter 110 is flipped relative to the view of FIGS. 1-3 to reveal jack pairs 420 and 430 opposite jack pairs 120 and 130 as described above. Accordingly, adapter 110 provides transmit low jacks 420, which includes “to field” jack 422 and “from C.O.” jack 424. “Receive High” jacks 430 include “to C.O.” jack 432 and “from field” jack 434. Connector 140 is not shown in this view.

FIG. 5 is a schematic circuit drawing of a specific embodiment of the present invention. Pin 1 is the leftmost pin on the foil side of connector 140. Pin 3 515 leads to tip 520 and pin 4 525 leads to ring 510 of the transmit low “to field” jacks to form loop 1 side 1 (out). Pin 5 535 leads to tip 540 and pin 6 545 leads to ring 530 of the transmit low “from C.O.” jacks to form loop 1 side 1 (in).

Continuing with FIG. 5, Pin 8 555 leads to tip 560 and pin 9 565 leads to ring 550 of the receive high “to C.O.” jacks to form loop 2 side 2 (out). Pin 11 575 leads to tip 580 and pin 12 585 leads to ring 570 of the receive high “from field” jacks to form loop 2 side 2 (in).

In operation, connector 140 connects to a midspan repeater case slot for testing. Alligator clip assemblies having a plug at one end to insert into any jack of adapter 110 and also having at least two alligator clips distal from the plug, plug into a jack of adapter 110 and the alligator clip portion attaches to a meter (Sidekick™) to test a cable pair. Two or more vinyl boots are optionally provided for the alligator clips. Spade lugs may be optionally used instead of alligator clips, but may need to be manually adjusted to obtain a suitable friction fit to the meter test leads. ⅛th inch plugs and jacks are suitable for many embodiments of the invention.

The adapter of the present invention is suitable for use in enclosures and situations where the repeater is obstructed on its end, such as by the hold-down brackets in the pressurized Keptel™ cases found in manholes, and in some situations above ground. The adapter has jacks on both sides to accommodate whatever orientation the repeater has depending on the slot it is in.

Advantageously, checking cable pairs to the C.O. or to the field with the present invention is very quick and safe. Due to the design of the pigtail(s) used during the testing, the Sidekick™ (meter) never has to be disconnected from the pigtail. The technician only has to move the pigtail into the marked jack of the section of cable he wishes to test. The insulating boots of the pigtail slide on and off the meter attaching clips for easy meter lead attachment to provide a shockproof and short-proof connection. There is no stray voltage to shock the technician. Furthermore, the device of the invention is easy to manufacture.

An additional advantage of the adapter is that with 2 pigtail assemblies, a “throwdown,” or Network Channel Terminating Equipment (“NCTE”) device can be optionally attached to the adapter to operationally check the F1 cable pairs.

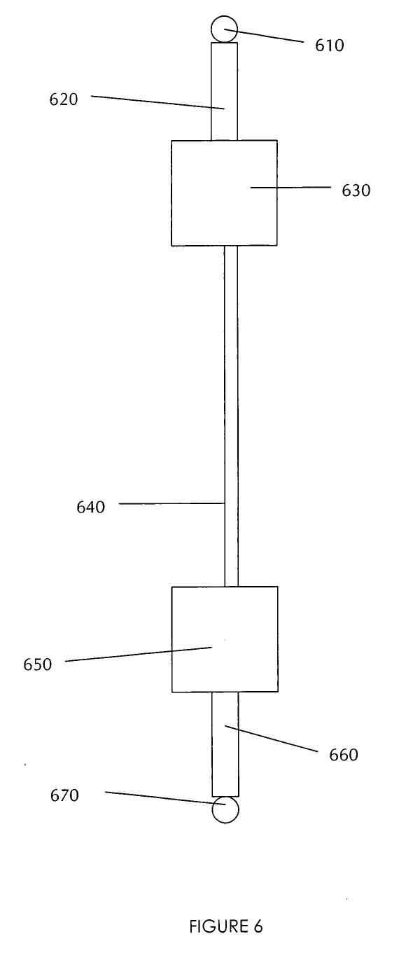

FIG. 6 is schematic side view drawing of a loop jumper of specific embodiment of the present invention. The cable pair test adapter of the invention can be configured to obtain loops toward the Central Office or towards the customer (field) using a loop jumper such that depicted in FIG. 6. Additionally, two loop jumpers can be used to loop the C.O. “to-from” pairs and field “to-from” pairs simultaneously.

An exemplary loop jumper provides insulated conductor wires 640 capped at each end by plugs 630 and 650. A jumper may be wired tip to tip and ring to ring. Plug 630 provides tip 610 and ring 620. Plug 650 provides ring 660 and tip 670. ⅛th inch plugs, for example, are suitable for many applications.

To loop the C.O. pairs, insert the jumper into “from C.O.” and “to C.O.” jacks in adapter 10. To loop field pairs, insert the jumper into the “from Field” and “to Field” jacks.

To perform any testing on a complete loop (from C.O. to customer), configure the adapter as “cut thru” that connects the C.O. and the field pairs together as a complete loop. Install a loop jumper into the “to Field” and “from C.O.” jacks for one side and “to C.O.” and “from Field” jacks with a second jumper to complete a circuit from the C.O. to the customer through adapter 110.

Loop jumper configurations of the present invention are useful for measuring loop resistances in the circuits, and for measuring the total stress (noise) on a complete circuit.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

1-5. (canceled)

6. An adapter connectable to a midspan repeater slot and to a meter for testing cable pairs, the adapter comprising:
a transmit low circuit having disposed on a first side of the adapter a first set of “to field” jacks and a set of first “from C.O.” jacks, and disposed on a second side of the adapter at least a second set of “to field” jacks and at least a second set of “from C.O.” jacks;
a receive high circuit having disposed on the first side of the adapter at least one first set of ‘to C.O.” jacks and at least one first set of “from field’ jacks, and on the second side of the adapter a second set of “to C.O.” jacks and a second set of “from field’ jacks; and
a pin assembly connected to the jacks to form one or more electrical loops, wherein the pin assembly is connectable to the midspan repeater slot and at least one set of the transmit low circuit jacks and at least one set of the receive high circuit jacks is connectable to the meter.

7. The adapter of claim 6, wherein the second side is adjacent to the first side.

8. The adapter of claim 6, wherein the second side is distal to the first side.

9. The adapter of claim 6, wherein the second side is opposite the first side.
